(19) United States
(12) Patent Application Publication
(10) Pub. No.: US 2026/0321684 A1
(43) Pub. Date: Oct. 15, 2026

(54) Bipolar Plate for a Fuel Cell, Fuel Cell Comprising Such Bipolar Plates and Method for Producing Such a Fuel Cell

(71) Applicant: SYMBIO FRANCE, Saint-Fons (FR)

(72) Inventors: Clément Guillaume Santini, Sainte Foy Les Lyon (FR); Florian Sébastien Ghio, Villeurbanne (FR)

(21) Appl. No.: 19/481,023

(22) PCT Filed: May 3, 2024
(86) PCT No.: PCT/EP2024/062219

§ 371 Date: Nov. 3, 2025

(30) Foreign Application Priority Data
May 4, 2023 (FR) FR2304480

(51) Int. Cl. H01M 8/0202

(52) U.S. Cl. CPC H01M 8/0202

(57) ABSTRACT

This bipolar plate includes two plates, anode and cathode, which are provided with channels for circulating a reactive fluid. The bottom walls of the channels form identical parallel waves which are regularly distributed along a distribution axis and are spaced apart in pairs by a pitch, denoted p. Each of the waves defines a mean axis perpendicular to the distribution axis. Each wave is delimited by two opposite and parallel longitudinal edges, which are spaced apart by a wave width, denoted l1 or l2, and define a neutral fiber, midway between the two longitudinal edges. Each wave includes first and second top portions which are arranged on the same first or second side of the mean axis of the wave and aligned in a direction parallel to the mean axis. The waves have the same offset D along the distribution axis. The offset is such that D=p+x where min(l1, l2)/2≤x≤(l1+l2)/2.

The present invention relates to a bipolar plate for a fuel cell. It also relates to a fuel cell comprising such bipolar plates, as well as a method for producing such a fuel cell.

A fuel cell is a device that enables generating electricity through an electrochemical reaction between a fuel, typically hydrogen, and an oxidant, typically oxygen contained in the air. Of interest here are fuel cells comprising several cells, each constituting an electrochemical generator and stacked against each other in a stacking direction. Schematically, each cell comprises an anode plate and a cathode plate, which extend perpendicularly to the stacking axis and between which an electrolyte is interposed. The invention is particularly applicable in cases where the electrolyte is in the form of a proton exchange membrane, or PEM. In such a case, the membrane, on its side facing the anode plate, is covered or in contact with an anode catalytic layer and, on its side facing the cathode plate, with a cathode catalytic layer. The assembly of the membrane and the anode and cathode catalytic layers forms a membrane-electrode assembly, generally referred to by its acronym “MEA”, with gas diffusion layers that are arranged on each side of the membrane. Generally, the cathode and/or anode catalytic layer is deposited by coating, printing, etc., for example, either on the corresponding side of the membrane or on the side of the corresponding gas diffusion layer facing the membrane. For each pair of two immediately adjacent cells, the anode plate of one of the two cells of the pair and the cathode plate of the other of the two cells of the pair are directly applied against each other along the stacking axis and form a bipolar plate in its operational state. In some embodiments, in the operational state of the bipolar plate, the anode plate and the cathode plate are fixed to each other by welding, brazing or gluing, for example. In other embodiments, in the operational state of the bipolar plate, the anode plate and the cathode plate are clamped against each other, in particular by compression clamping imposed on the stack of cells of the pile. Each of the two plates of each bipolar plate, respectively anode and cathode, delimits, on its side facing away from the other plate of the bipolar plate, channels for circulating a reactive fluid, typically hydrogen and oxygen respectively, which are covered by the respective membrane-electrode assemblies belonging to the respective two cells sharing the bipolar plate. Between the two plates of each bipolar plate, in the operational state of the latter, free passages are delimited for circulating a cooling fluid, such as glycol water.

Of more interest to the invention are the bipolar plates, whose channels in which the reactive fluids, typically hydrogen and oxygen, circulate, do not extend in length in a straight line but in a wavy manner, with the channel waves of each of the two plates of each bipolar plate being out of phase with the channel waves of the other plate of the bipolar plate, as, for example, in U.S. Pat. No. 7,781,122. The respective bottom walls of the channels of each of the two plates of each bipolar plate are generally flat so that, at the assembly interface between the two plates, they rest in substantially flat contact against the bottom walls of the other of the two plates in the operational state of the bipolar plate: due to the wave of the channels and their being out-of-phase, the contact between the two plates of each bipolar plate is made between a multitude of contact zones, each of which is small and distributed at the assembly interface between the two plates. In principle, the overall pattern formed by these contact zones at the interface between the two plates of each bipolar plate is predictable, since it is a function of the geometric characteristics of the wavy bottom walls of the channels of each of the two plates and the relative positioning of these two plates in the operational state of the bipolar plate. This overall pattern enables controlling both the mechanical stability of the assembly of the two plates and the electrical connection between them: therefore, it is generally sought to maximize the cumulative extent of the contact zones while ensuring their distribution at the contact interface. However, in practice, the relative positioning of the two plates in the operational state of the bipolar plate often suffers from a tolerance much greater than the manufacturing tolerance of the wavy channels of each plate, particularly because the stacking of the plates induces a positioning uncertainty that is intrinsic to the assembly operations of the fuel cell. As a result, in the operational state of each bipolar plate, the overall pattern actually formed by the contact zones at the interface between the two plates of the bipolar plate does not ultimately correspond to the desired overall pattern but, on the contrary, risks inducing degraded performance for the mechanical stability of the assembly of the two plates and/or for the electrical connection between them.

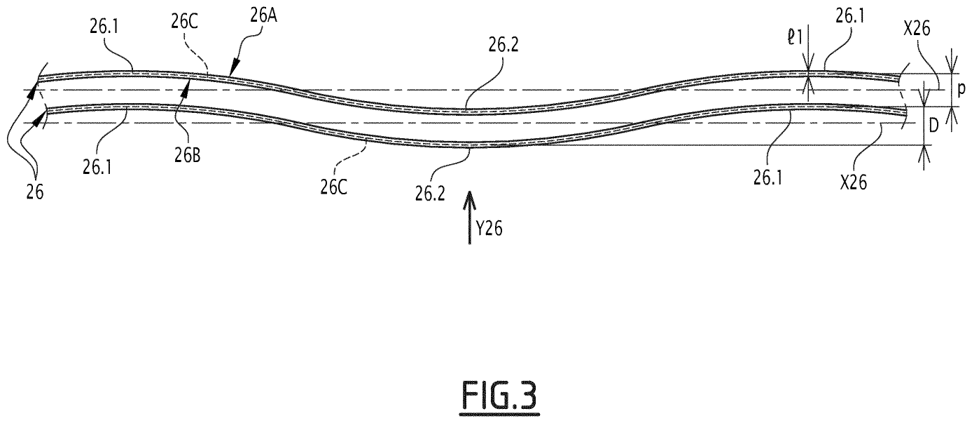

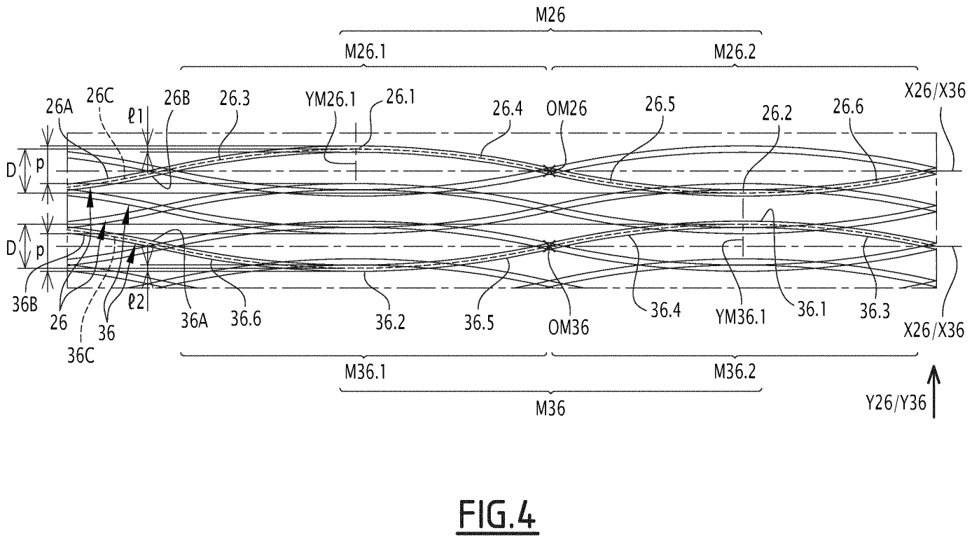

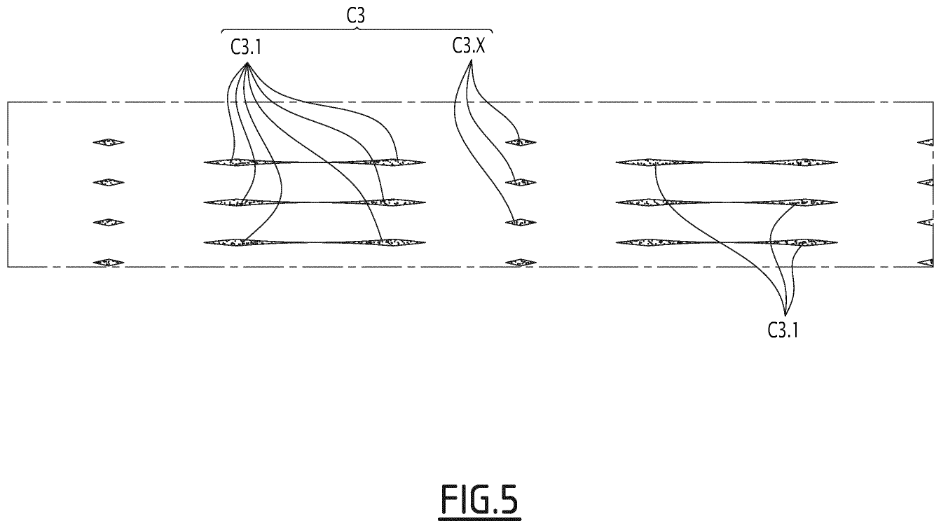

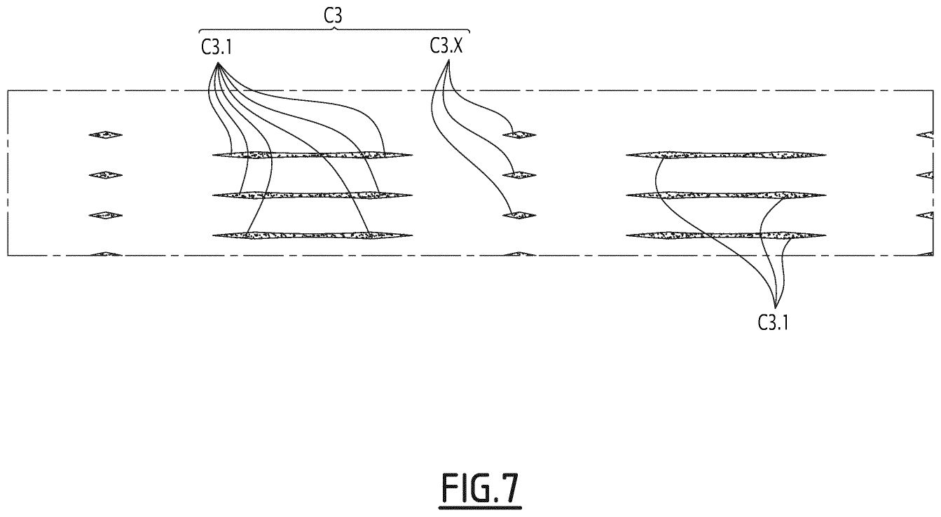

For its part, US 2021/0143451 discloses a bipolar plate including an anode plate and a cathode plate applied directly against each other along a stacking axis. A membrane-electrode assembly is interposed between two stacked bipolar plates. For each of its bipolar plates, US 2021/0143451 provides that (i) the cathode plate delimits channels forming a flow field for a gas containing oxygen on its surface facing away from the anode plate, in other words, on its side facing the membrane-electrode assembly, with these channels being delimited by wavy reliefs of the cathode plate, and (ii) the anode plate delimits channels forming a flow field for a gas containing hydrogen on its side facing away from the cathode plate, in other words, on its side facing the membrane-electrode assembly, with these channels being delimited by wavy reliefs of the anode plate. The wavy reliefs of the cathode plate include cathode peaks that are directly supported against the membrane-3 electrode assembly, more precisely against a cathode face of the latter, while the wavy reliefs of the anode plate include anode peaks that are directly supported against the membrane-electrode assembly, more precisely against an anode face of the latter. The cathode peaks are drawn in elevation in FIG. 4 of US 2021/0143451 while the anode peaks are drawn in elevation in FIG. 3 of US 2021/0143451. In FIG. 5 of US 2021/0143451, the superposition of the cathode peaks and the anode peaks is drawn, highlighting the high surface pressure zones where the membrane-electrode assembly is locally sandwiched between respective parts of the cathode peaks and the anode peaks, aligned with each other along the stacking axis. These high surface pressure zones are represented alone in FIG. 7 of US 2021/0143451. Thus, US 2021/0143451 details the relative arrangement of the peaks, respectively cathode and anode, of the cathode and anode plates of each of its bipolar plates, but does not detail the relative arrangement of the bottom walls of the channels delimited by the respective cathode plate and the anode plate, that is to say, the walls of these channels, applied directly in contact with each other.

The aim of the present invention is to propose a bipolar plate with out-of-phase wavy channels whose mechanical and electrical performance of the contact interface between the two plates of the bipolar plate is controlled, despite the uncertainty of the assembly positioning between the two plates.

To this end, the invention relates to a bipolar plate for a fuel cell, as defined in claim 1.

The operational state of the bipolar plate is that found when the pile is assembled and operational.

One of the ideas underlying the invention is to seek to maximize the mechanical and electrical performance of the contact interface between the two plates of the bipolar plate, while taking into account a usual positioning tolerance between the two plates in the operational state of the bipolar plate. To do this, the invention provides that the waves of the anode plate, identical and parallel to each other, and the waves of the cathode plate, identical and parallel to each other, are out of phase and have the same pitch, while being able to have a wave width that is either identical or different between the two plates. According to the invention, the offset of the waves of the anode plate and that of the waves of the cathode plate, which are the same, are provided to be equal to the sum between the aforementioned pitch and a predetermined value that is between half of the smallest of the two wave widths, inclusively, and half of the sum of the two wave widths, inclusively. In a nominal configuration of the operational state of the bipolar plate, wherein the mean axes of the waves of the anode plate are aligned, along the stacking direction of the two plates, with the respective mean axes of the waves of the cathode plate, the contact zones between the two plates form an overall pattern at their assembly interface that presents good mechanical and electrical performance: in particular, as described in more detail below, each top part of each wave of one of the two plates is applied against one of the top parts of the waves of the other of the two plates, forming a double diamond contact zone, whose two diamonds are connected by a strip whose minimum width is comprised between zero and half of the largest of two wave widths. One of the interests of the invention is to maintain these double diamond contact zones when the two plates of the bipolar plate are not exactly in the nominal configuration, in the operational state, but in a non-nominal configuration where the mean axes of the waves of the anode plate are offset relative to the mean axes of the waves of the cathode plate, this offset being due to the usual positioning tolerance of the two plates during their assembly and being typically of the same order of magnitude as half of the sum of the two wave widths. By means of the invention, whatever the positioning gap that is actually present between the two plates in the operational state of the bipolar plate, within the limits of the usual positioning tolerance, the offset prescribed by the invention enables guaranteeing contact zones between the two plates, which are both sufficiently extensive in total to ensure a good electrical connection between the two plates, and sufficiently distributed at the interface between the two plates to ensure good mechanical stability of the assembly of the two plates, and, in doing so, ensure good performance for a fuel cell comprising a stack of bipolar plates according to the invention. Furthermore, the control of the mechanical and electrical performance of the bipolar plate according to the invention is advantageously optimized by playing on the geometric characteristics of the waves of the two plates, as described in more detail below.

Thus, additional advantageous characteristics of the bipolar plate according to the invention are specified in claims 2 to 8.

The invention also relates to a fuel cell, as defined in claim 9.

The invention also relates to a method for producing a fuel cell as defined above, this method being as defined in claim 10.

The manufacturing method according to the invention takes advantage of the fact that the mechanical and electrical performance of the fuel cell is guaranteed, regardless of the actual positioning gap between the two plates of each bipolar plate during the assembly of the latter, within the limits of the usual positioning tolerance.

The invention will be better understood by reading the following description, given solely by way of example and made with reference to the drawings in which:

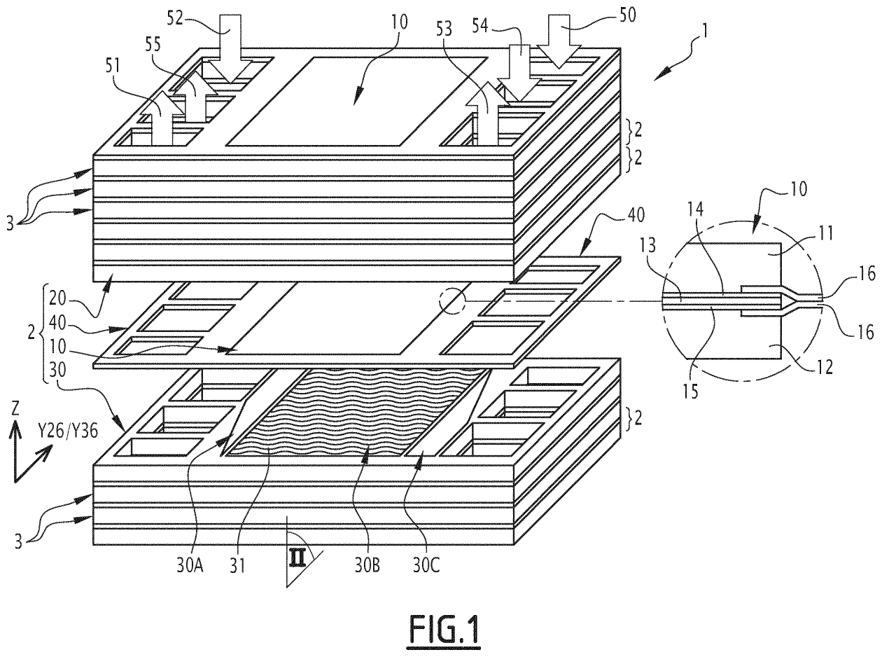

FIG. 1 is an exploded perspective view of a fuel cell according to the invention;

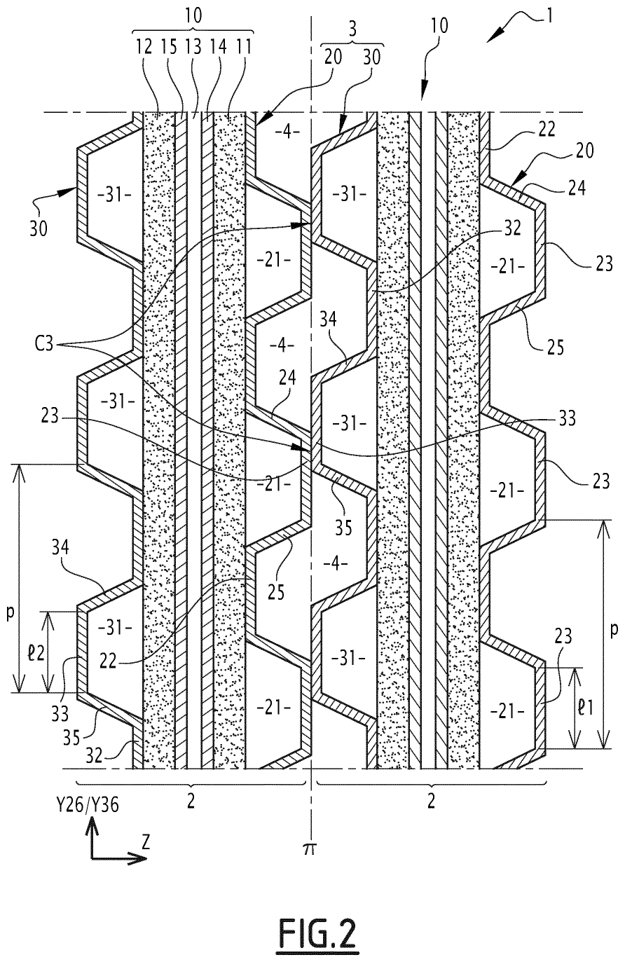

FIG. 2 is a partial schematic section according to plane Il of FIG. 1;

FIG. 3 is a diagram illustrating channel waves of one of the two plates of a bipolar plate according to the invention, belonging to the fuel cell of FIGS. 1 and 2;

FIG. 4 is a view similar to FIG. 3, illustrating the superposition of the respective waves of the two plates of the bipolar plate;

FIG. 5 is a diagram of contact zones between the two plates of the bipolar plate, resulting from the superposition of the waves illustrated in FIG. 4;

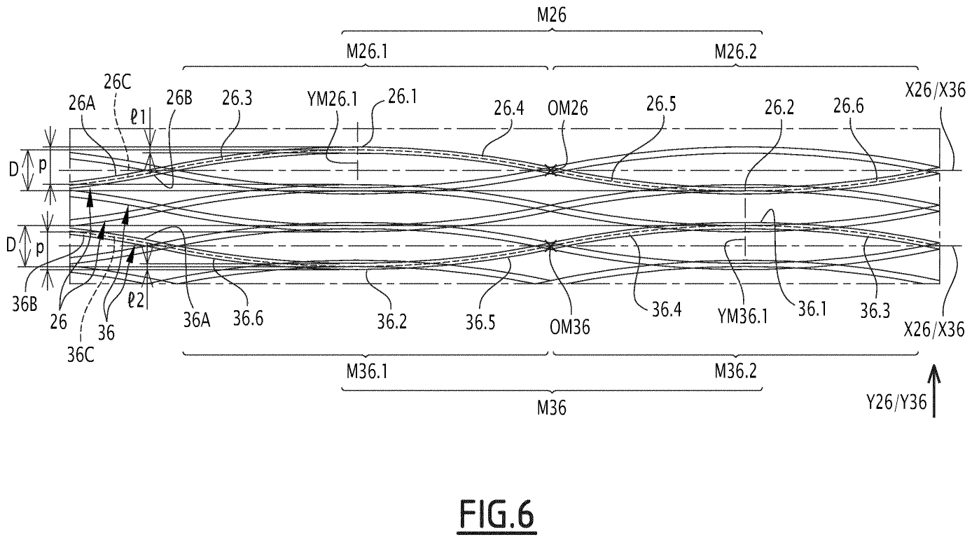

FIG. 6 is a view similar to FIG. 4, illustrating a variant of dimensioning for the respective waves of the two plates of the bipolar plate according to the invention;

FIG. 7 is a view similar to FIG. 5 but applied to the superposition of the waves illustrated in FIG. 6;

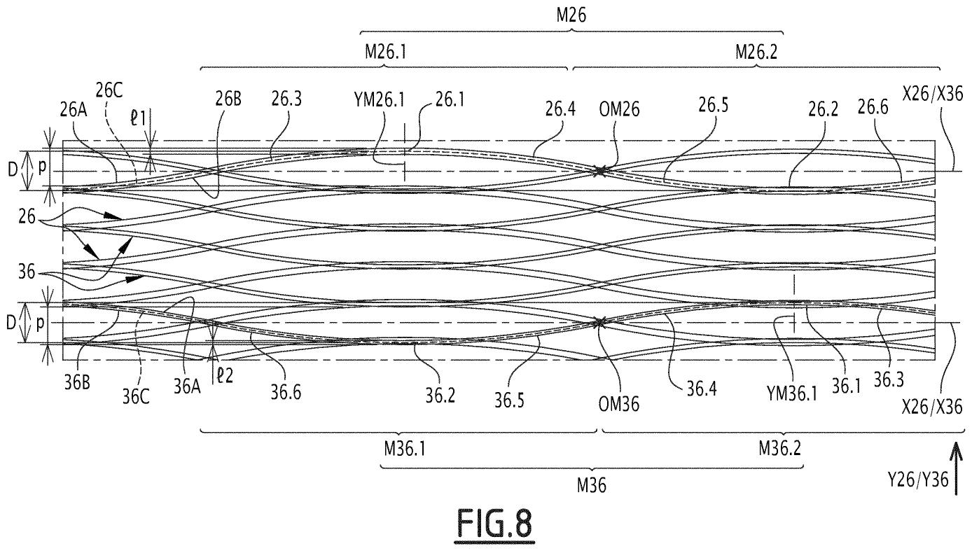

FIG. 8 is a view similar to FIG. 4, illustrating another variant of dimensioning for the respective waves of the two plates of the bipolar plate according to the invention; and

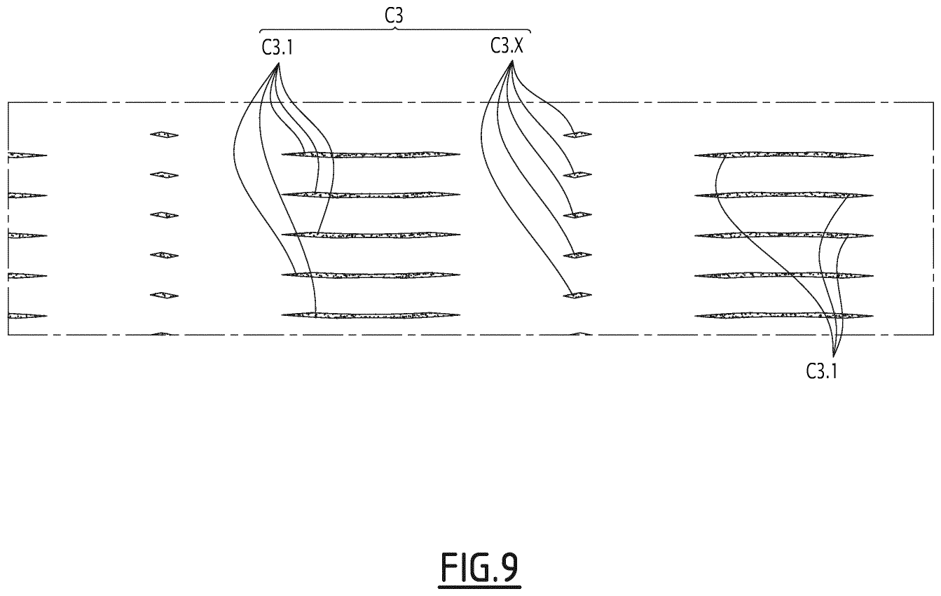

FIG. 9 is a view similar to FIG. 5 but applied to the superposition of the waves illustrated in FIG. 8.

In FIG. 1, a fuel cell 1 is represented. The fuel cell 1 is intended to be installed in a vehicle, for example, and to produce electricity from reactive fluids such as hydrogen and oxygen to power an electric motor, ensuring the propulsion of the vehicle.

The fuel cell 1 comprises a stack of cells 2, wherein the cells 2 are arranged against each other along a stacking axis Z. The stack of cells 2 is maintained between two terminal plates, which are not represented in FIG. 1 and which in particular enable maintaining the stack of cells 2 compressed, that is to say clamped, along the stacking axis Z, and to supply this stack with both a reactive fuel fluid and a reactive oxidant fluid. According to a preferred example on which we will rely subsequently, the reactive fuel fluid is constituted of hydrogen in gaseous form and the reactive oxidant fluid is constituted of oxygen in gaseous form, with it noted that, in practice, the fuel cell 1 may not be supplied with pure oxygen, but with air, or even with a gaseous mixture comprising oxygen, such as a mixture of oxygen and nitrogen, a mixture that may be in a ratio between oxygen and nitrogen that is similar to that of air, or in a different ratio. Here, the terms “oxygen” and “dioxygen” are undifferentiated; similarly, the terms “hydrogen” and “dihydrogen” are undifferentiated. For simplification of expression, the terms “oxygen” and “dioxygen” will also cover air or any gaseous mixture containing oxygen in a non-negligible proportion.

As represented in FIGS. 1 and 2, each cell 2 comprises a membrane-electrode assembly 10 whose detail of a section is integrated into FIG. 1.

Each cell 2 also comprises two polar plates arranged on either side of the membrane-electrode assembly 10, along the stacking axis Z, namely an anode plate 20 and a cathode plate 30. For each cell 2, the anode plate 20 enables supplying the cell 2 with hydrogen while the cathode plate 30 enables supplying this cell with oxygen. To this end, as clearly visible in FIG. 2, the anode plate 20 delimits channels 21 for circulating hydrogen, on its side facing the membrane-electrode assembly 10, while the cathode plate 30 delimits channels 31 for circulating oxygen, on its side facing the membrane-electrode assembly 10. For each pair of two immediately adjacent cells 2, the anode plate 20 of one of the two cells and the cathode plate 30 of the other of the two cells are arranged directly against each other along the stacking axis Z and form a bipolar plate 3, in the operational state of the fuel cell 1. Thus, in the operational state of the fuel cell 1, the two cells 2 of each pair of immediately adjacent cells share the same bipolar plate 3 that separates the membrane-electrode assembly 10 of one of these two cells 2 and the membrane-electrode assembly 10 of the other of these two cells 2 from each other. In the operational state of each bipolar plate 3, the channels 21 are delimited by the side of the anode plate 20 of the bipolar plate 3, facing away from the cathode plate 30 of the bipolar plate 3, while the channels 31 are delimited by the side of the cathode plate 30 of the bipolar plate 3, facing away from the anode plate 20 of this bipolar plate 3. Also in the operational state of each bipolar plate 3, the anode 20 and cathode 30 plates of the bipolar plate 3 form free passages 4 between them, for circulating a cooling fluid, separated from the channels 21 and 31. The cooling fluid plays no direct role in the electrochemical reactions occurring in the cells 2, but the circulation of this cooling fluid enables controlling the temperature of the cells 2, thus the temperature of the electrochemical reaction, and thus the operating conditions of the electrochemical reaction.

In practice, each of the plates 20 and 30 is a shaped sheet, particularly stamped, made of metal. However, the invention can also be implemented with other plate embodiments, which can be made of other materials, particularly graphite, for example, and/or which can be shaped otherwise than by stamping, such as by machining, chemical etching, electro-erosion, or by additive manufacturing.

Before describing the channels 21 and 31 in more detail, the structural and functional characteristics of the membrane-electrode assembly 10 of each cell 2 are described below, with it being emphasized that the specificities of these characteristics are not limiting. Thus, in the embodiment considered in the figures, the membrane-electrode assembly 10 of each cell 2 includes two gas diffusion layers 11 and 12, which are arranged, along the stacking axis Z, on either side of a proton exchange membrane 13 whose two opposite sides are covered by, or in contact with, an anode catalytic layer 14 and a cathode catalytic layer 15, respectively. In the assembled state of the fuel cell 1, each cell 2 thus comprises, successively along the stacking axis Z, the anode plate 20, the gas diffusion layer 11, the anode catalytic layer 14, the proton exchange membrane 13, the cathode catalytic layer 15, the gas diffusion layer 12, and the cathode plate 30.

For each cell 2, the gas diffusion layer 11 covers the channels 21 and enables the transport of hydrogen from the channels 21 of the anode plate 20 to the anode catalytic layer 14. Similarly, the gas diffusion layer 12 covers the channels 31 and enables the transport of oxygen from the channels 31 of the cathode plate 30 to the cathode catalytic layer 15. In practice, the gas diffusion layers 11 and 12 are made of a porous material, such as a carbon fiber cloth or a porous carbon paper.

For each cell 2, the proton exchange membrane 13 enables conducting the hydrogen ions, or protons, from the anode catalytic layer 14 to the cathode catalytic layer 15, while preventing the circulation of electrons. The proton exchange membrane 13 is made of a perfluorinated sulfonic polymer material, for example, such as the material known under the trade name of “Nafion”. The proton exchange membrane 13 also enables the circulation of water in liquid form, for the purpose of evacuating the water produced at the level of the cathode catalytic layer 15 out of the cell 2.

Within each cell 2, when the fuel cell 1 is in operation, an oxidation reaction occurs at the level of the anode catalytic layer 14, consisting of catalytically splitting the hydrogen supplied by the gas diffusion layer 11 into protons and electrons. The protons thus produced cross the proton exchange membrane 13 until they reach the cathode catalytic layer 15, while the electrons thus produced are captured by the anode plate 20 and then conducted to the cathode plate 30 of the bipolar plate 3 to which the anode plate 20 of the considered cell 2 belongs. At the same time, a reduction reaction occurs at the level of the cathode catalytic layer 15 and consists of reacting the oxygen supplied by the gas diffusion layer 12 with the protons crossing the proton exchange membrane 13, as well as with electrons supplied by the cathode plate 30 of the considered cell 2, to form water molecules.

In practice, the anode 14 and cathode 15 catalytic layers are made of porous structures, which enable the transport of reactive fluids, that is, the hydrogen and oxygen here, inside these catalytic layers, and which are made of three different materials, namely:
a material for transporting protons, such as the same material as the proton exchange membrane 13, such as the “Nafion” material mentioned above,
a material for transporting electrons, such as carbon, and
a material for catalyzing the electrochemical oxidation and reduction reactions described above, such as platinum.

In practice, the membrane-electrode assembly 10 of each cell 2, which is interposed between the anode 20 and cathode 30 plates of the considered cell 2, also comprises a support frame 40. Advantageously, the support frame 40 is formed of two superimposed and glued films 16, such as PET or PEN films, themselves in the form of a frame. to delimit an internal window whose contour is slightly smaller than the contour of the proton exchange membrane 13, the contour of which is trapped, along the contour of the internal window, between the two films of the support frame 40.

Also, before describing the channels 21 and 31 in more detail, it will be noted, as schematically illustrated in FIG. 1, that the fuel cell 1 comprises a hydrogen inlet 50, supplying hydrogen to the anode plates 20, and a hydrogen outlet 51, evacuating hydrogen from the anode plates 20. The fuel cell 1 also comprises an oxygen inlet 52, supplying oxygen to the cathode plates 30 and an oxygen outlet 53, evacuating oxygen from the cathode plates 30. The fuel cell 1 also comprises a cooling fluid inlet 54, supplying cooling fluid to the bipolar plates 3 and a cooling fluid outlet 55, evacuating the cooling fluid from the bipolar plates 3. In the embodiment illustrated in the figures, the inlets 50, 52 and 54, as well as the outlets 51, 53 and 55, are formed by openings made in the anode plates 20, the cathode plates 30 and the support frames 40. In practice, these inlets and outlets are connected to corresponding openings, which are made in one of the two aforementioned terminal plates and which are themselves connected to supply circuits for hydrogen, oxygen and cooling fluid. In a non-represented variant, these inlets and outlets are formed by conduits arranged around the stack of cells 2, in an ad hoc housing of the fuel cell 1.

As schematically represented in FIG. 1, each cathode plate 30 includes three adjacent zones that successively connect the oxygen inlet 52 to the oxygen outlet 53, namely a homogenization zone 30A, an active zone 30B, which is connected to the oxygen inlet 52 by the homogenization zone 30A, and a homogenization zone 30C, connecting the active zone 30B to the oxygen outlet 53. The channels 31 of the cathode plate 30 extend in length over the entire active zone 30B, each connecting the homogenization zone 30A to the homogenization zone 30C. The active zone 30B has substantially the same dimensions as the window delimited by the support frame 40 of the membrane-electrode assembly 10 of the cell 2 to which the considered cathode plate 30 belongs, and it is generally provided that the gas diffusion layer 12 entirely covers at least the active zone 30B. The homogenization zones 30A and 30C, which connect the respective oxygen inlet 52 and the oxygen outlet 53 to the active zone 30B, enable distributing oxygen over the entire transverse extent of the active zone 30B, that is to say, in all the channels 31.

Each anode plate 20 includes an active zone and two homogenization zones, which are similar to the respective active zone 30B and the homogenization zones 30A and 30C of each cathode plate 30: the two homogenization zones of each anode plate connect the respective hydrogen inlet 50 and the hydrogen outlet 51 to the active zone of this anode plate and enable distributing hydrogen over the entire transverse extent of this active zone, that is to say, in all the channels 21 extending in length over this entire active zone, from one to the other of the two homogenization zones.

In the embodiment considered in the figures, the bipolar plates 3 and the support frames 40 have a rectangular peripheral contour. Moreover, the hydrogen inlet 50 and the hydrogen outlet 51 are located diagonally from each other while the oxygen inlet 53 and the oxygen outlet 53 are also located diagonally from each other, which enables obtaining a more homogeneous distribution of the reactive fluids over the respective active zones of the anode 20 and cathode 30 plates.

We will now focus in more detail on the structural and dimensional characteristics of the channels 21 of the anode plates 20 and the channels 31 of the cathode plates 30, relying on FIGS. 2 to 9. It will be noted that these characteristics differ between the embodiment illustrated in FIGS. 4 and 5, the embodiment illustrated in FIGS. 6 and 7, and the embodiment of FIGS. 8 and 9, as explained below.

As schematically represented in FIG. 2, the channels 21 of each anode plate 20 are separated in pairs, over their entire length, by tooth walls 22 belonging to the anode plate 20. In the assembled state of the fuel cell 1 to which the anode plate 20 belongs, these tooth walls 22 are entirely applied, along the stacking axis Z, directly against the membrane-electrode assembly 10 of the relevant cell 2, more precisely against the gas diffusion layer 11 of this membrane-electrode assembly 10. Similarly, the channels 31 of each cathode plate 30 are separated in pairs, over their entire length, by tooth walls 32 belonging to the cathode plate 30: in the assembled state of the cell 2 to which the cathode plate 30 belongs, the tooth walls 32 are entirely applied, along the stacking axis Z, directly against the membrane-electrode assembly 10 belonging to the relevant cell 2, more precisely to the gas diffusion layer 12 of this membrane-electrode assembly 10. In practice, the tooth walls 22 and 32 are each substantially flat, within manufacturing tolerances.

Also as schematically represented in FIG. 2, each of the channels 21 is delimited, over its entire length, by both a bottom wall 23, a side wall 24 that connects the bottom wall 23 to one of the two adjacent tooth walls 22 of the considered channel 21, and a side wall 25 that connects the bottom wall 23 to the other of the aforementioned two tooth walls 22. The bottom wall 23 and the side walls 24 and 25 belong to the anode plate 20. Similarly, each of the channels 31 is delimited, over its entire length, by both a bottom wall 33, a side wall 34 and a side wall 35, all belonging to the cathode wall 30, the side wall 24 connecting the bottom wall 23 to one of the two adjacent tooth walls 32 of the considered channel 31 while the side wall 25 connects the bottom wall 23 to the other of these two tooth walls 32. In the operational state of each bipolar plate 3, the bottom walls 23 of the anode plate 20 belonging to the considered bipolar plate 3 are directly in contact, along the stacking axis Z, against the bottom walls 33 of the cathode plate 30 belonging to the considered bipolar plate 3, forming contact zones C3 between the anode 20 and cathode 30 plates. In practice, for this purpose, the bottom walls 23 and 33 are substantially flat, so that, at the level of the contact zones C3, these bottom walls 33 and 23 are in substantially flat contact. For each bipolar plate 3, the contact zones C3 are arranged in a geometric plane π that is perpendicular to the stacking axis Z. The free passages 4, which are formed between the anode 20 and cathode 30 plates of each bipolar plate 3 for circulating the cooling fluid, extend in the extent of the geometric plane π, outside the contact zones C3.

As very schematically illustrated for the channels 31 in FIG. 1, the channels 21 and 31 do not extend in length in a straight line, but in a wavy manner, at least over a major part of their length. Indeed, it can be provided that the channels, particularly at their end connecting with the homogenization zones, include segments, particularly end segments, whose geometry is different from the geometry they present in a main segment, particularly a central segment that extends between these possible end segments. The geometry of these main segments of the channels is considered below. More precisely, for each of the bipolar plates 3, the bottom walls 23 and the bottom walls 33 form respective waves 26, 36, in orthogonal projection on the geometric plane π: in FIG. 3, whose plane corresponds to the geometric plane π, two of the waves 26 are represented alone while in FIG. 4, whose plane also corresponds to the geometric plane π, several of the waves 26 and several of the waves 36 are represented in the operational state of the corresponding bipolar plate 3. It is understood that the regions of the geometric plane IT in FIG. 4, at the level at which the waves 26 of the anode plate 20 and the waves 36 of the cathode plate 30 overlap, correspond to the contact zones C3. In FIG. 5, whose plane also corresponds to the geometric plane π, only the contact zones C3 are drawn and shaded, to better visualize them. As detailed below, of the contact zones C3, the summit contact zones C3.1 on the one hand and the axial contact zones C3.X on the other hand will be distinguished.

As clearly visible in FIGS. 3 and 4, for each bipolar plate 3, the waves 26 of a given bipolar plate 3 are identical to each other and parallel to each other, being regularly distributed in the geometric plane IT along a distribution axis Y26. These waves 26 are thus spaced apart in pairs by a constant pitch, which is denoted p in FIGS. 2, 3, 4, 6, and 8. Similarly, for each bipolar plate 3, the waves 36 of a bipolar plate 3 are identical to each other and parallel to each other, being regularly distributed in the geometric plane IT along a distribution axis Y36, which is coincident with the distribution axis Y26, within positioning tolerances, in the operational state of the bipolar plate 3. The waves 36 are thus are spaced apart in pairs by a constant pitch, which is equal to the pitch p of the waves 26 and which is therefore also denoted p in FIGS. 2, 4, 6, and 8.

As clearly visible in FIGS. 4, 6 and 8, for each bipolar plate 3, the waves 26 of the anode plate 20 of a given bipolar plate 3 are out of phase with the waves 36 of the cathode plate of the said given bipolar plate 3, in the operational state of the bipolar plate 3.

As indicated in FIGS. 3, 4, 6 and 8, for each bipolar plate 3, each of the waves 26 of the anode plate 20 defines a mean axis X26, which is perpendicular to the distribution axis Y26 and along which the corresponding wave 26 extends in length while alternating on either side of this mean axis X26. The respective mean axes X26 of the waves 26 all belong to the geometric plane IT and are parallel to each other. Similarly, for each bipolar plate 3, each of the waves 36 of the cathode plate 30 defines a mean axis X36, which is perpendicular to the distribution axis Y36 and along which the corresponding wave 36 extends in length while alternating on either side of the mean axis X36. The respective mean axes X36 all belong to the geometric plane π and are parallel to each other. In the operational state of each bipolar plate 3, the mean axes X26 and the mean axes X36 are parallel to each other: more precisely, in a nominal configuration of the operational state of the relevant bipolar plate 3, the mean axes X26 are coincident with the respective mean axes X36, as illustrated in FIGS. 4, 6, and 8. Conversely, in a non-nominal configuration of this operational state, resulting from a usual relative positioning tolerance that is intrinsic to the manufacture of each bipolar plate 3 by stacking the anode 20 and cathode 30 plates of the latter, the mean axes X26 are not coincident with the mean axes X36, but are offset from the latter along the distribution axes Y26 and Y36, the corresponding offset being called δ in what follows. The value of this offset δ is in any case strictly less than half of the pitch p which is common to the waves 26 on the one hand and to the waves 36 on the other hand, preferably strictly less than a quarter of this pitch p.

In all cases, it will therefore be possible to define two waves 26 and 36, one belonging to the anode plate 20 and the other belonging to the cathode plate 30, as being two corresponding waves of the bipolar plate 3, when the mean axis X26 of one is coincident with the mean axis X36 of the other, or when their mean axes X26, X36 are offset from each other by an offset less than half of the pitch p which is common to the waves 26 of the anode plate 20 on the one hand and to the waves 36 of the cathode plate 30 on the other hand, preferably strictly less than a quarter of this pitch p.

As the waves 26 of the anode plate 20 of a given bipolar plate 3 are out of phase with the waves 36 of the cathode plate 30 of the said given bipolar plate 3 in the operational state of the bipolar plate 3, each wave 26 of the anode plate 20 and the corresponding wave 36 of the cathode plate 30 necessarily cross at the level of their mean axis to form the axial contact zones C3.X, among the contact zones 3.

As illustrated in FIGS. 3 and 4, for each bipolar plate 3, each of the waves 26 of the anode plate 20 is delimited, over its entire length, by two longitudinal edges 26A and 26B, which are opposite to each other along the distribution axis Y26 and which, here, each undulate on either side of the mean axis X26 of the relevant wave 26. These longitudinal edges 26A and 26B are parallel to each other, being spaced from each other by a width of the corresponding wave 26, denoted 11 in FIGS. 2, 3, 4, 6, and 8. Since the waves 26 are identical to each other, the width 11 is the same for all the waves 26 and, for each of these waves 26, is constant over the entire length of the wave. It is thus possible, for each of the waves 26 of the anode plate 20 of each bipolar plate 3, to define a neutral fiber 26C as being the wavy line that extends both parallel and midway between the two longitudinal edges 26A and 26B of the relevant wave 26.

In the same way, and as illustrated in FIG. 4, for each bipolar plate 3, each of the waves 36 of each cathode plate 30 is delimited, over its entire length, by two longitudinal edges 36A and 36B, which are opposite to each other along the distribution axis Y36 and which, here, each undulate on either side of the mean axis X36 of the relevant wave 36. These longitudinal edges 36A and 36B are parallel to each other, being spaced from each other by a width of the corresponding wave 36, denoted 12 in FIGS. 2, 3, 4, 6 and 8. Since the waves 36 are identical to each other, the width 12 is the same for all the waves 36 and, for each of these waves 36, is constant over the entire length of the wave. It is thus possible, for each of the waves 36 of the cathode plate 30 of each bipolar plate 3, to define a neutral fiber 36C as being the wavy line that extends both parallel and midway between the two longitudinal edges 36A and 36B of the relevant wave 36.

It will be noted that the width l1 and the width l2 are equal to each other both in the embodiment illustrated in FIGS. 4 and 5 and in the embodiment illustrated in FIGS. 6 and 7. However, in the embodiment illustrated in FIGS. 8 and 9, the width l1 is different from the width l2: here, the width l1 is strictly greater than the width l2; however, in a non-represented variant, the width l1 can be provided strictly less than the width l2.

As illustrated in FIGS. 3, 4, 6 and 8, each of the waves 26 of each anode plate 20 includes, as the longitudinal parts furthest from the mean axis X26 of the relevant wave 26 along the distribution axis Y26, both first top portions 26.1, which are arranged on the same first side of the mean axis X26, and second top portions 26.2, which are arranged on the same second side, opposite the first aforementioned side, of the mean axis X26. The top portions 26.1 of each wave 26 are aligned with each other in a direction parallel to the relevant mean axis X26. Similarly, the top portions 26.2 are aligned with each other in a direction parallel to the relevant mean axis X26. Similarly, and as illustrated in FIGS. 4, 6, and 8, each of the waves 36 of each cathode plate 30 includes, as the longitudinal parts furthest from the mean axis X36 of the relevant wave 36 along the distribution axis Y36, both first top portions 36.1, which are arranged on the same first side of the mean axis X36, and second top portions 36.2, which are arranged on the same second side, opposite the first aforementioned side, of the mean axis X36. The top portions 36.1 of each wave 36 are aligned with each other in a direction parallel to the relevant mean axis X36. Similarly, the top portions 36.2 are aligned with each other in a direction parallel to the relevant mean axis X36.

According to a preferred embodiment, which is implemented in the embodiments illustrated in the figures and which present, among other advantages, to simplify the design and manufacture of the anode 20 and cathode 30 plates of each bipolar plate 3, each of the respective waves 26, 36, of each respective anode 20, cathode 30 plate, is constituted of the repetition of a respective wave pattern M26, M36. More precisely, the wave pattern M26, which is identical here for the different waves 26 of each anode plate 20, comprises only one of the first top portions 26.1 and only one of the second top portions 26.2, and is repeated several times successively along the mean axis X26 of each wave 26, to constitute the entirety of the latter. In the same way, the wave pattern M36, which is identical here for the different waves 36 of each cathode plate, comprises only one of the first top portions 36.1 and only one of the second top portions 36.2, and is repeated several times successively along the mean axis X36 of each wave 36, to constitute the entirety of the latter, in some examples.

In order to further reinforce the simplification of the design and manufacture of the anode 20 and cathode 30 plates of each bipolar plate 3, the respective wave pattern M26, M36, is preferably constituted of two sections that succeed each other along the respective mean axis X26, X36, which are arranged on either side of this mean axis, namely a respective first section M26.1, M36.1, which includes the respective first summit part 26.1, 36.1, of the respective wave pattern M26, M36, and a respective second section M26.2, M36.2, which comprises the respective second summit part 26.2, 36.2, of the respective wave pattern M26, M36. The respective first section M26.1, M36.1, thus comprises, in addition to the respective first summit part 26.1, 36.1 of the respective wave pattern M26, M36, two longitudinal parts 26.3 and 26.4 of the respective corresponding wave 26, 36.3 and 36.4 of the corresponding wave 36, which each connect the respective first summit part 26.1, 36.1, to the respective mean axis X26, X36 of the corresponding wave. Similarly, the respective second section M26.2, M36.2, comprises, in addition to the respective second summit part 26.2, 36.2 of the respective wave pattern M26, M36, two longitudinal parts 26.5 and 26.6 of the respective corresponding wave 26, 36.5 and 36.6 of the corresponding wave 36, which each connect the respective second summit part 26.2, 36.2 to the respective mean axis X26, X36 of the corresponding wave. The longitudinal parts 26.4 and 26.5, respectively 36.4 and 36.5, are directly connected to each other, at the level of the respective mean axis X26, X36. The respective first section M26.1, M36.1 has a respective symmetry axis YM26.1, YM36.1, which extends perpendicularly to the mean axis X26 of the respective corresponding wave 26, X36 of the corresponding wave 36, and which passes through the first summit part 26.1 of the respective wave pattern M26, 36.1 of the wave pattern M36: this respective symmetry axis YM26.1, YM36.1 constitutes a symmetry axis for the respective first summit part 26.1, 36.1 and the longitudinal parts 26.3 and 26.4, respectively 36.3 and 36.4, are symmetrical to each other in relation to this respective symmetry axis YM26.1, YM36.1. Moreover, the respective second section M26.2, M36.2 is symmetrical to the respective first section M26.1, M36.1 in relation to a respective point OM26, OM36, which is formed at the intersection between the respective corresponding mean axis X26, X36 and the respective corresponding neutral fiber 26C, 36C: thus, the respective longitudinal part 26.5, 36.5 is symmetrical to the respective longitudinal part 26.4, 36.4 in relation to this respective symmetry point OM26, OM36; the respective second summit part 26.2, 36.2, is symmetrical to the respective summit part 26.1, 36.1 in relation to this respective symmetry point OM26, OM36; and the respective longitudinal part 26.6, 36.6 is symmetrical to the respective longitudinal part 26.3, 36.3 in relation to this respective symmetry point OM26, OM36.

In all cases, each wave 26 of each anode plate 20 has an offset, denoted D in FIGS. 3, 4, 6, and 8, this offset D corresponding to the spacing along the distribution axis Y26 and measured at the level of the neutral fiber 26C of the relevant wave 26, between the first top portions 26.1 and the second top portions 26.2 of the relevant wave 26. Since the waves 26 of the anode plate 20 are identical to each other, this offset D is the same for all the waves 26. Similarly, each wave 36 of each cathode plate 20 has an offset corresponding to the spacing along the distribution axis Y36 and measured at the level of the neutral fiber 36C of the relevant wave 36, between the first top portions 36.1 and the second top portions 36.2 of the relevant wave 36: this offset of the waves 36 of the cathode plate 30, which is the same for all the waves 36 since the latter are identical to each other, is the same as the offset D of the waves 26 of the anode plate 20. and is therefore also denoted D in FIGS. 4, 6, and 8.

This offset D of the waves 26 and 36 of each bipolar plate 3 is dimensioned to respect the following relationship:

D=p+x, where min(l1, l2)/2≤x≤(l1+l2)/2.

In other words, the offset D is equal to the sum of the pitch p and a predetermined value x that is inclusively between half of the smallest of the widths l1 and l2 and inclusively half of the sum of the widths l1 and l2.

In the embodiment of FIGS. 4 and 5, where the widths l1 and l2 are equal, the offset D is chosen as equal to the sum of the pitch and half of the width l1 or l2. In other words, D=p+l1=p+l2.

In the embodiment of FIGS. 6 and 7, where the widths l1 and l2 are also equal to each other, the offset D is chosen as equal to the sum of the pitch p and the width l1 or l2. In other words, D=p+l1/2=p+l2/2.

In the embodiment of FIGS. 8 and 9, where one of the widths, here the width l1, is strictly greater than the other width, here the width l1, with moreover the largest of the two widths, here therefore the width l1, strictly greater than the smallest of the two widths, here the width l2, the offset D is chosen as equal to the sum between the pitch p and half of the smallest width l2. In other words, D=p+l2/2.

In all cases, the above relation, in the nominal configuration of the operational state of each bipolar plate 3, and for all the waves 26 of the anode plate 20 except for the end waves 26 along the distribution axis Y26, enables bringing into contact the top portions 26.1 of each wave 26 of the anode plate 20 with the respective top portions 36.2 of an adjacent wave 36 of the cathode plate 30, and to bring into contact the top portions 26.2 of the same wave 26 of the anode plate 20 with the respective top portions 36.1 of another adjacent wave 36 of the cathode plate 30, forming between them summit contact zones C3.1 among the contact zones C3. For a given wave 26 of the anode plate 20, the two adjacent waves 36 of the cathode plate 30 are the two waves that are immediately adjacent to the corresponding wave 36 of the cathode plate 30 as defined above, namely having the mean axis X36 coincident with the mean axis X26 of the given wave 26 or presenting an offset strictly less than half of the wave pitch p.

Conversely, the above relation, in the nominal configuration of the operational state of each bipolar plate 3, and for all the waves 36 of the cathode plate 30 except for the end waves 36 along the distribution axis Y36, enables bringing into contact the top portions 36.1 of each wave 36 of the cathode plate 30 with the respective top portions 26.2 of an adjacent wave 26 of the anode plate 20, and to bring into contact the top portions 36.2 of the same wave 36 of the cathode plate 30 with the respective top portions 26.1 of another adjacent wave 26 of the anode plate 20, forming between them summit contact zones C3.1 among the contact zones C3. For a given wave 36 of the cathode plate 30, the two adjacent waves 26 of the anode plate 20 are the two waves 26 that are immediately adjacent to the corresponding wave 26 of the anode plate 20 as defined above, namely having the mean xis X26 coincident with the mean axis X36 of the given wave 36 or presenting an offset strictly less than half of the wave pitch p.

More precisely, it is noted that each given wave 26 of the anode plate 20, except for the end waves 26 along the distribution axis Y26, is thus in contact with exactly 3 distinct waves 36 of the cathode plate 30, namely:
with the corresponding wave 36 of the cathode plate 30, to form the axial contact zones C3.X for this given wave 26;
with a first adjacent wave 36 of the cathode plate 30, at the level of its top portions 26.1, to form half of the summit contact zones C3.1 for this given wave 36;
and with a second adjacent wave 36 of the cathode plate 30, at the level of its top portions 26.2, to form the other half of the summit contact zones C3.1 for this given wave 26.

Conversely, each given wave 36 of the anode plate 30, except for the end waves 36 along the distribution axis Y36, is thus in contact with exactly 3 distinct waves 26 of the anode plate 20, namely:
with the corresponding wave 26 of the anode plate 20, to form the axial contact zones C3.X for this given wave 36;
with a first adjacent wave 26 of the anode plate 30, at the level of its top portions 36.1, to form half of the summit contact zones C3.1 for this given wave 36;
and with a second adjacent wave 36 of the cathode plate 30, distinct from the first, at the level of its top portions 36.2, to form the other half of the summit contact zones C3.1 for this given wave 36.

In a particularly advantageous manner, the above relation enables that a summit contact zone C3.1 is necessarily found, for each wave 26 of the anode plate 20 and each wave 36 of the cathode plate 30, between two immediately successive axial contact zones C3.X. Thus, except for the end waves 26, 36 along the distribution axis Y26, Y36, there is no summit zone that is not in contact with a wave of the opposite plate.

As clearly visible in FIGS. 5, 7, and 9, each of the summit contact zones C3.1 has a double diamond shape, including two diamonds and a strip that connects the two aforementioned diamonds and whose minimum width is between zero, as in the embodiment of FIGS. 4 and 5, and half of the largest of the two widths 11 and 12, as in the embodiment of FIGS. 6 and 7, as well as in the embodiment of FIGS. 8 and 9. It will be noted that the term “diamond” used here is not understood in its strict geometric sense, but as an evocation of a shape. In the case where the operational state of one of the bipolar plates 3 is not in the nominal configuration, the offset δ mentioned above does not call into question the obtaining of the summit contact zones C3.1, even if the actual contour of each of these summit contact zones C3.1 differs somewhat from the double diamond shape described above for the nominal configuration, as long as this offset δ is of the same order of magnitude as the widths l1 and l2, typically having the min value (l1, l2) of the smallest of the width l1 and the width l2. In this regard, as a non-limiting example, the widths l1 and l2 are typically comprised between 0.1 mm and 1 mm, preferably between 0.1 and 0.5 mm, while the usual positioning tolerance between the anode 20 and cathode 30 plates of each bipolar plate 3 induces a value of about 0.15 mm for the offset δ.

Thus, and more generally, by applying the above relationship, the obtaining of the contact zones C3, in particular the summit contact zones C3.1, is guaranteed and in this way the mechanical and electrical performance at the contact interface between the anode 20 and cathode 30 plates of each bipolar plate 3 is controlled, whatever the actual positioning of these two plates during their assembly within the limits of the usual positioning tolerance.

In practice, various geometric characteristics of the waves 26 and 36 of each bipolar plate 3 can be played on to control the value of the offset D. According to a practical, efficient, and economical possibility, which is implemented here, the top portions 26.1 and 26.2 of each wave 26, respectively 36.1 and 36.2 of each wave 36, are each curved, preferably following a circular profile: in this way, the curvature radius of these top portions 26.1 and 26.2, respectively 36.1 and 36.2, can be played on, it being noted that the respective top portions 26.1, 36.1 have a concavity that is opposite to that of the respective top portions 26.2, 36.2. That being said, other possibilities are conceivable: as non-represented examples, the top portions 26.1 and 26.2, respectively 36.1 and 36.2, are each curved but following a sinusoidal profile, or these top portions 26.1 and 26.2, respectively 36.1 and 36.2, are each rectilinear, following a flat profile.

Taking into account the explanations given thus far, it is understood that the fuel cell 1 is preferably manufactured by first placing one of the anode plates 20 and one of the cathode plates 30 on either side of each of the membrane-electrode assemblies 10, along the stacking axis Z, in order to form the different cells 2, then by assembling the anode 20 and cathode 30 plates of each bipolar plate 3 together. That being said, other possibilities are conceivable for manufacturing the fuel cell 1. In general, the anode 20 and cathode 30 plates of each bipolar plate 3 can be assembled to each other in different ways, including by brazing, welding, gluing, or by simple assembly by compression of the stack of cells.

Finally, various arrangements and variants to the bipolar plate 3 and the fuel cell 1 described so far are conceivable. For example, the different variants mentioned at different points in the above description can be combined with each other, at least partially.

1-10. (canceled)

11. A bipolar plate for a fuel cell, including two plates, respectively anode and cathode, which are applied against each other along a stacking axis, in the operational state of the bipolar plate;
wherein each of the two plates, on its side facing away from the other plate, delimits channels for circulating a reactive fluid, each having a bottom wall in contact with a bottom wall of a unique channel of the other of the two plates;
wherein the bottom walls of the channels of each of the two plates form respective waves, in orthogonal projection on the same geometric plane perpendicular to the stacking axis which, for each of the two plates:
are identical and parallel to each other, being regularly distributed along a distribution axis and are spaced apart in pairs by a pitch, denoted p, the pitch of the waves associated with the anode plate being equal to the pitch of the waves associated with the cathode plate; and
in the operational state of the bipolar plate, are out of phase with the waves associated with the other of the two plates;
wherein each of the waves associated with each of the two plates defines a mean axis:
which is perpendicular to the distribution axis;
along which the wave extends in length while alternating on either side of the mean axis; and
which, in a nominal configuration of the operational state of the bipolar plate, is coincident with one of the mean axes of the waves associated with the other of the two plates;
wherein each of the waves associated with each of the two plates is delimited by two longitudinal edges which:
are opposite to each other along the distribution axis;
are parallel to each other, being spaced from each other by a wave width, the wave width of the waves associated with the anode plate being denoted 11 while the width of the waves associated with the cathode plate is denoted 12; and
define a neutral fiber of the wave, which extends both parallel and midway between the two longitudinal edges;
wherein each of the waves associated with each of the two plates comprises first and second top portions, as the longitudinal parts furthest from the mean axis along the distribution axis, the first top portions being both arranged on the same first side of the mean axis of the wave and aligned with each other in a direction parallel to the mean axis, while the second top portions are both arranged on the same second side, opposite the first side, of the mean axis of the wave and aligned with each other in a direction parallel to the mean axis; and
wherein the waves associated with the anode plate and the waves associated with the cathode plate have the same offset, denoted D, which corresponds to the spacing, along the distribution axis and measured at the level of the neutral fiber, between the first top portions and the second top portions of each wave, the offset being such that D=p+x, where min(l1, l2)/2≤x≤(l1+l2)/2.

12. The bipolar plate according to claim 11, wherein the wave width l1 of the waves associated with the anode plate is equal to the wave width l2 of the waves associated with the cathode plate.

13. The bipolar plate according to claim 11, wherein the wave width l1 of the waves associated with the anode plate is strictly greater than the wave width l2 of the waves associated with the cathode plate.

14. The bipolar plate according to claim 11, wherein the wave width l1 of the waves associated with the anode plate is strictly less than the wave width l2 of the waves associated with the cathode plate.

15. The bipolar plate according to claim 11, wherein each of the waves associated with each of the two plates comprises a wave pattern which:
is identical between the waves of each of the two plates;
comprises only one of the first top portions and only one of the second top portions of the wave; and
is repeated several times successively along the mean axis of the wave to constitute the wave.

16. The bipolar plate according to claim 15, wherein the wave pattern of each of the waves associated with each of the two plates is constituted of a first section and a second section, which succeed each other along the mean axis of the wave and which are arranged on either side of the mean axis of the wave, comprising the respective first summit part and the second summit part of the wave pattern; and
wherein the first section has a symmetry axis, which extends perpendicularly to the mean axis of the wave and which passes through the first summit part of the wave pattern, and wherein the second section is symmetrical to the first section in relation to a point formed at the intersection between the mean axis and the neutral fiber of the wave.

17. The bipolar plate according to claim 11, wherein the first and second top portions of each of the waves associated with each of the two plates are each curved.

18. The bipolar plate according to claim 17, wherein each of the first and second top portions of each of the waves associated with each of the two plates follows a circular profile.

19. A fuel cell, including bipolar plates, each of which is according to claim 11, and which are stacked against each other along the stacking direction, with interposition of a membrane-electrode assembly between two successive bipolar plates.

20. A method for producing a fuel cell according to claim 19, wherein, before assembling the anode and cathode plates of each of the bipolar plates together, each of the membrane-electrode assemblies is assembled with one of the anode plates and one of the cathode plates, applied on either side, along the stacking axis, of the relevant membrane-electrode assembly.
